(19) United States
(12) Patent Application Publication
(10) Pub. No.: US 2014/0081953 A1
(43) Pub. Date: Mar. 20, 2014

(54) SYSTEM AND METHOD FOR PROVIDING ANSWERS IN AN ON-LINE CUSTOMER SUPPORT ENVIRONMENT

(71) Applicant: Salesforce.com, Inc, San Francisco, CA (US)

(72) Inventors: Lauren Ingram, San Francisco, CA (US); Antony Passemard, San Francisco, CA (US)

(73) Assignee: Salesforce.com, Inc, San Francisco, CA (US)

(21) Appl. No.: 14/016,985

(22) Filed: Sep. 3, 2013

Related U.S. Application Data
(60) Provisional application No. 61/695,991, filed on Aug. 31, 2012.

(51) Int. Cl. G06F 17/30

(52) U.S. Cl. CPC G06F 17/30554
USPC 707/722

(57) ABSTRACT

Methods and systems are provided for providing answers in an on-line customer support site. The method includes receiving a first question from a user, determining first results from a knowledge base, determining second results from a community, determining third results from an agent, and displaying the first results, the second results, and the third results responsive to the first question in a single, integrated feed.

### CROSS-REFERENCE TO RELATED APPLICATION

This application claims the benefit of U.S. provisional patent application Ser. No. 61/695,991 filed Aug. 31, 2012, the entire contents of which are incorporated herein by this reference.

### TECHNICAL FIELD

Embodiments of the subject matter described herein relate generally to computer systems and applications for managing customer support queries in an on-line community, and more particularly to displaying a single integrated feed which integrates both knowledge base search results and customer support agent interaction.

### BACKGROUND

The unprecedented growth of social technologies has redefined the way people connect and communicate. On-line social networking sites such as Facebook™, Pinterest™, Tumblr™, Google+™, Hootsuite™, and Twitter™ have forever changed the way people share information with each other. In business environments, customer community sites have changed the way consumers seek and share information about a company's products and services. General purpose Q & A communities such as Lithium™ and /b/Board (by 4Chan™), as well as proprietary branded communities such as Apple™ Computer's discussion board powered by Jive™, provide consumers with a list-based interface for finding and sharing information about a company's products and services. Presently known customer support sites allow users to either pose questions to customer support agents, access the company's knowledge base, or share information with the community, but are not integrated with each other and, thus, function as silos.

At the same time, software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users.

Presently known customer support sites do not effectively integrate archival knowledge with customer service agent interaction. Systems and methods are thus needed which provide an integrated online customer support solution.

### BRIEF DESCRIPTION OF THE DRAWING FIGURES

A more complete understanding of the subject matter may be derived by referring to the detailed description and claims when considered in conjunction with the following figures, wherein like reference numbers refer to similar elements throughout the figures.

FIG. 1 is a schematic block diagram of a multi-tenant computing environment in accordance with an embodiment;

FIG. 2 is a schematic block diagram of an exemplary screen layout for a customer support user interface in accordance with an embodiment;

FIG. 3 is a schematic block diagram of an exemplary module for posting a question to the community and/or for creating a customer support ticket in accordance with an embodiment;

FIG. 4 is an exemplary agent window for use in responding to the open ticket created in FIG. 3 in accordance with an embodiment;

FIG. 5 is an alternate embodiment of the agent window shown in FIG. 4 in accordance with an embodiment;

FIG. 6 is an alternate implementation of the screen layout of FIG. 2 in accordance with an embodiment;

FIG. 7 is a flow diagram of an exemplary method for answering a customer support question in accordance with an embodiment; and

FIG. 8 is an alternate implementation of the screen layout of FIGS. 2 and 6 in accordance with an embodiment.

### DETAILED DESCRIPTION

Embodiments of the subject matter described herein generally relate to systems and methods for implementing a three-tiered customer support paradigm involving an archival knowledge base, community or peer support, and interaction with a customer support agent (if necessary) seamlessly integrated into a single display feed.

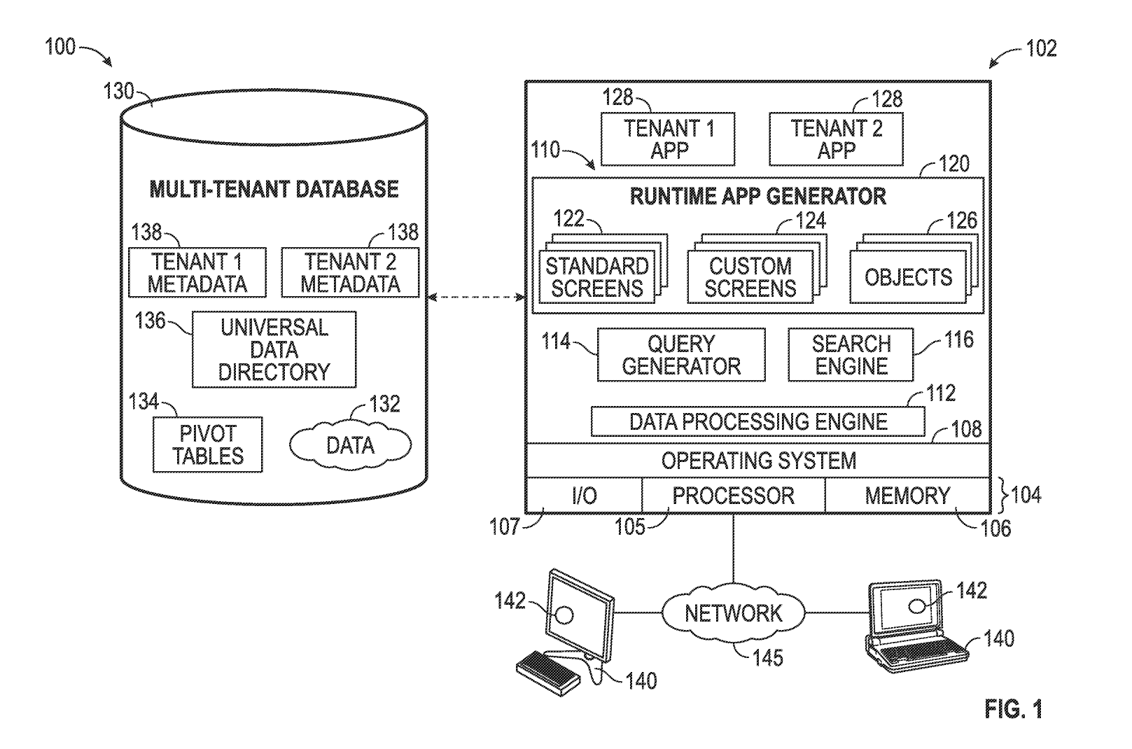

Turning now to FIG. 1, an exemplary cloud based solution may be implemented in the context of a multi-tenant system 100 including a server 102 that supports applications 128 based upon data 132 from a database 130 that may be shared between multiple tenants, organizations, or enterprises, referred to herein as a multi-tenant database. Data and services generated by the various applications 128 are provided via a network 145 to any number of client devices 140, such as desk tops, laptops, tablets, smartphones, Google Glass™, and any other computing device implemented in an automobile, aircraft, television, or other business or consumer electronic device or system, including web clients.

In addition to the foregoing “dedicated” syncing clients, the present disclosure also contemplates the automatic sharing of data and files into applications, such as Microsoft Word™, such that saving a document in Word would automatically sync the document to the collaboration cloud. In an embodiment, each client device, application, or web client is suitably configured to run a client application 142, such as the Chatterbox file synchronization module or other application for performing similar functions, as described in greater detail below.

An alternative vector into the automatic syncing and sharing may be implemented by an application protocol interface (API), either in lieu of or in addition to the client application 142. In this way, a developer may create custom applications/interfaces to drive the sharing of data and/or files (and receive updates) with the same collaboration benefits provided by the client application 142.

Each application 128 is suitably generated at run-time (or on-demand) using a common application platform 110 that securely provides access to the data 132 in the database 130 for each of the various tenant organizations subscribing to the service cloud 100. In accordance with one non-limiting example, the service cloud 100 is implemented in the form of an on-demand multi-tenant customer relationship management (CRM) system that can support any number of authenticated users for a plurality of tenants.

As used herein, a “tenant” or an “organization” should be understood as referring to a group of one or more users (typically employees) that shares access to common subset of the data within the multi-tenant database 130. In this regard, each tenant includes one or more users and/or groups associated with, authorized by, or otherwise belonging to that respective tenant. Stated another way, each respective user within the multi-tenant system 100 is associated with, assigned to, or otherwise belongs to a particular one of the plurality of enterprises supported by the system 100.

Each enterprise tenant may represent a company, corporate department, business or legal organization, and/or any other entities that maintain data for particular sets of users (such as their respective employees or customers) within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other organizations.

The multi-tenant database 130 may be a repository or other data storage system capable of storing and managing the data 132 associated with any number of tenant organizations. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

In an exemplary embodiment, the database 130 includes a database management system or other equivalent software capable of determining an optimal query plan for retrieving and providing a particular subset of the data 132 to an instance of application (or virtual application) 128 in response to a query initiated or otherwise provided by an application 128, as described in greater detail below. The multi-tenant database 130 may alternatively be referred to herein as an on-demand database, in that the database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants.

Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like.

The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The application platform 110 is any sort of software application or other data processing engine that generates the virtual applications 128 that provide data and/or services to the client devices 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the client devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the client devices 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its client device 140, as appropriate.

The runtime application generator 120 suitably interacts with the query generator 114 to efficiently obtain multi-tenant data 132 from the database 130 as needed in response to input queries initiated or otherwise provided by users of the client devices 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled client device 140 on the network 145. In an exemplary embodiment, the client device 140 includes a display device, such as a monitor, screen, or another conventional electronic display capable of graphically presenting data and/or information retrieved from the multi-tenant database 130, as described in greater detail below.

Typically, the user operates a conventional browser application or other client program 142 executed by the client device 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. However, if a user chooses to manually upload an updated file (through either the web based user interface or through an API), it will also be shared automatically with all of the users/devices that are designated for sharing.

As noted above, the virtual application 128 may contain Java, ActiveX, or other content that can be presented using conventional client software running on the client device 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128.

In various embodiments, virtual application 128 may include a feed-based customer support platform such as, for example, Chatter Answers™ available from salesforce.com. In this context, a feed implies that data and information threads (including conversations) are updated and displayed to the user interface, either directly or via an iframe, in real time or near real time. In contrast, prior art customer support platforms typically employ static, list-based platforms. Chatter Answers™ provides tenants with embedded functionality for implementing an online customer support community under a company's unique proprietary branding scheme such as U.S. Bank's Answers™ and the CompassLearning™ support portal.

In accordance with various embodiments, the interaction model comprises a user interface (UI) for database searching, posting questions to the community and to a customer support agent, and for displaying the results in a single, integrated feed having three principle components: i) search results from the company's knowledge base (e.g., previous Q&A, articles, frequently asked questions (FAQ)); ii) community forums; and iii) a template for opening a customer support ticket to initiate interaction with a customer support agent (e.g., live chat, delayed chat, live video, or the like).

In various embodiments, the user begins by typing, speaking, or otherwise entering a question into a query field within the UI. The question may be deflected, for example by prompting the user to disambiguate from among a plurality of stored questions relating to the original query. For example, the system may ask did you mean . . . .” to better focus or improve the form of the question, or to conform the question to a previously structured category. In an embodiment, previous Q&A's are merged with knowledge-based articles including linking between the Q&A and the articles and sorted by relevance to create deflection targets. As described in greater detail below, navigation is configured to drive all users having the same question to the latest (and the same) answer.

Customer support inquiries may be initially processed by interrogating the company's continuously updated knowledge base (e.g., previous Q&A's including best answers, FAQ's, articles). In this regard, the user interface may be configured to navigate the user from the search page to an answer using a minimum number (e.g., two) of navigation clicks. By properly prioritizing and organizing the results, the user may obtain an answer from the knowledge base without having to register with or log into the system. In this regard, Knowledge-Centered Support (KCS) methods and practices may be employed to manage a company's customer/technical support organization. KCS practices are maintained by the Consortium for Service Innovation, and include the KCS-Verified program available at http://www.thekcsacademy.net/tools/.

If the initial search results do not yield a satisfactory answer, the user may register with and/or log into the system, whereupon the question may be “posted” to the community for a predetermined amount of time (e.g., 24 hours) to allow the community to answer the question. In the context of various embodiments, by encouraging the community support itself, for example, by allowing members of the community to answer questions posted by other members, the company may reduce the costs otherwise incurred by customer support agents, currently (2013) estimated at about $7 USD to initiate a support ticket, and in the range of $50 to $200 to interact with an agent in answering a question. If the community provides a satisfactorily answer in a timely manner, the customer posing the question is satisfied, the member or members of the community providing assistance enhance their reputation within the community, and the company avoids the costs of an agent.

If neither the knowledge base nor the community provides a satisfactory answer, a customer support ticket may be opened, for example, by presenting the user with an interactive module (e.g., a pop-up window) to engage a customer support agent. The agent may interact with the user via text, audio, and/or video, in real time or otherwise. In addition, the customer support platform may be configured to communicate with the company's customer relationship management (CRM) system at the multitenant level. Consequently, when a user logs onto a company's customer support site, the system has the ability to identify the user's CRM data via the multitenant database server. Hence, a VIP customer may be prioritized over other customers in the support queue. Moreover, an agent servicing the call may simultaneous employ numerous other channels (e.g., Twitter, Facebook) in the feed to obtain a multidimensional view of the user.

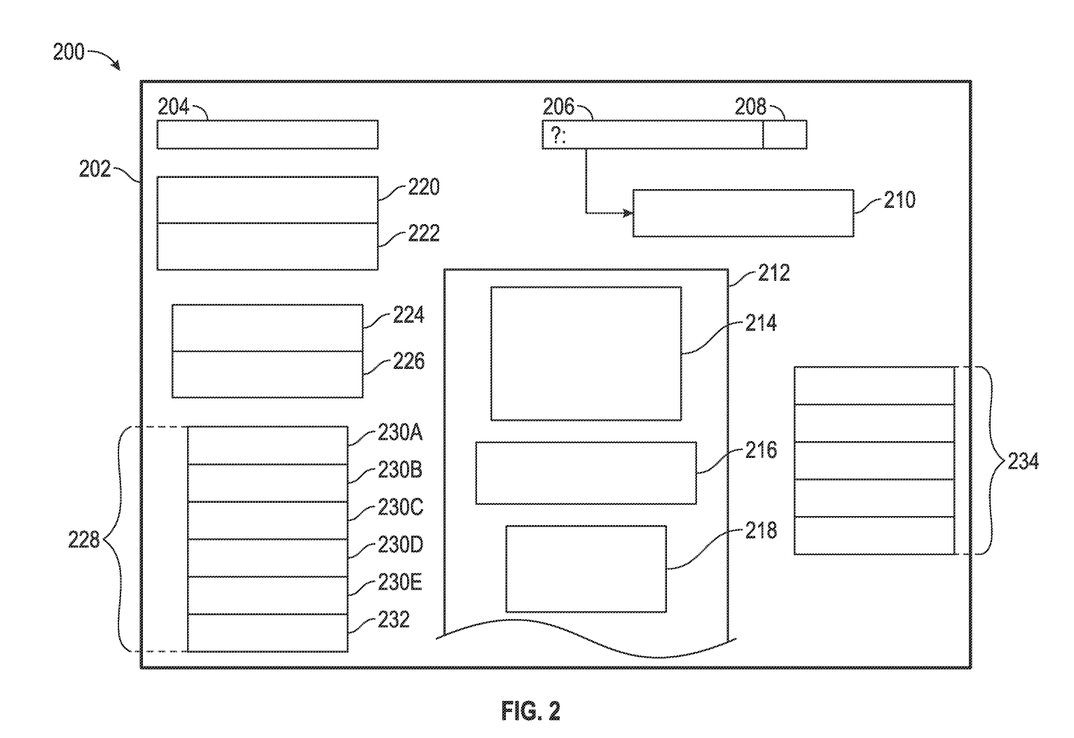

Referring now to FIG. 2, an exemplary layout 200 for a customer support user interface includes a screen 202 within a browser window. The screen 202 includes one or more branding indicia 204 such as the company name, logo, and the like, a login button 220, and a “sign up” or “register” function 222. A question field 206, a “Go” (or “Search”) virtual button 208, and a deflection field 210 allow the user to enter search terms (e.g., in the form of a question) into the system. Alternatively, the user may browse currently open questions 220, or quickly ascertain whether a particular question has a best answer associated with it by clicking a best answer button 226.

With continued reference to FIG. 2, search results may be displayed in a real time, continuously updatable feed 212 configured to display knowledge base results 214, community forum results 216, and/or agent interaction 218 in a unified, integrated manner sorted in accordance with predetermined relevancy scoring protocols. In addition, the search results may be sorted using one or more source-based filters 228 and/or one or more content-based filters 234. Source filters 28 may include, for example, articles 230A, Q&A 230B, forums 230C, Ideas 230D, blogs 230E, or “all” 232. Content filters 234 may include context specific topic filters.

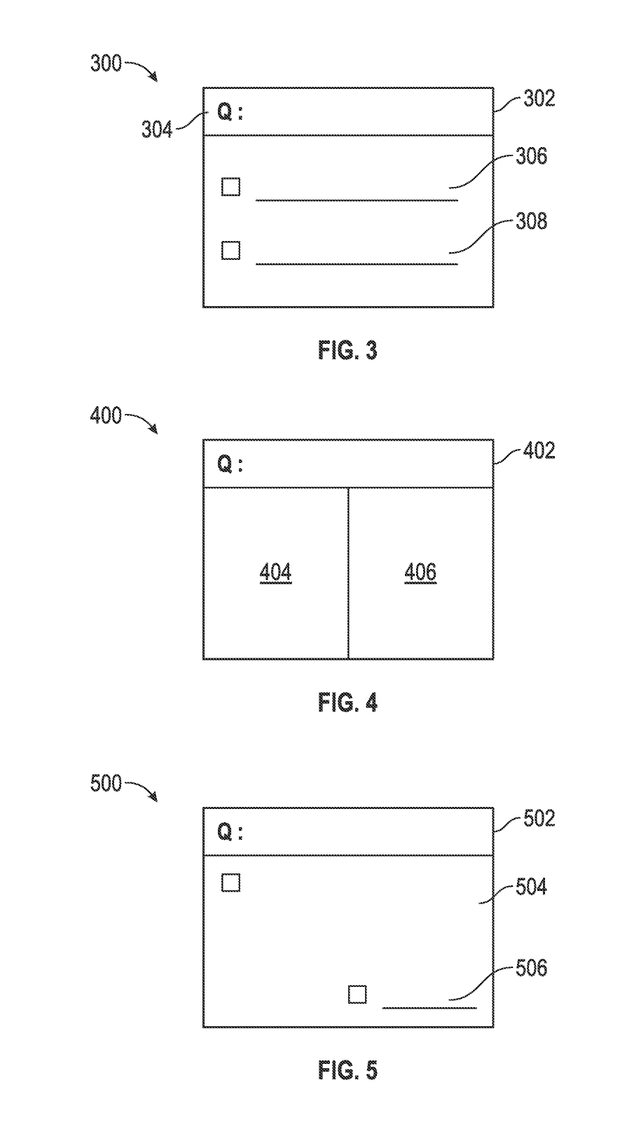

FIG. 3 is a schematic block diagram 300 of an exemplary interface module 302 (e.g., a pop-up window) for posting the question to the community and/or to a customer support agent. More particularly, if the user does not receive a satisfactory answer from the knowledge base, the user may copy or reformulate the question using a query field 302. In one embodiment, the user may direct the question to the community by selecting a community field 306, whereupon the community may provide answers within a predetermined (but configurable) period of time (e.g., 24 hours). If a satisfactory answer is not received from the community within the allotted window of time (or if an agent elects to override the window and provide an earlier response), the question may be assigned to a customer support agent. Alternatively, the user may bypass the community and direct the question immediately to an agent by deselecting the community field 306.

With continued reference to FIG. 3, the user may designate the agent interaction as either private or public using a public/private indicator field 308. Once a customer support ticket is opened, the question is presented to an appropriate level customer service/support agent.

FIG. 4 is an exemplary agent window 400 for use in responding to the open ticket created in FIG. 3. In accordance with an embodiment, window 400 includes a question field 402, a private sector 404 for providing a confidential response directly to the user, and a public sector 406 for providing an answer to the user which may also be shared with the community.

FIG. 5 is an alternate embodiment of the agent window shown in FIG. 4. More particularly, FIG. 5 depicts an agent window 500 including a question field 502, a response field 504, and a public/private toggle function 506.

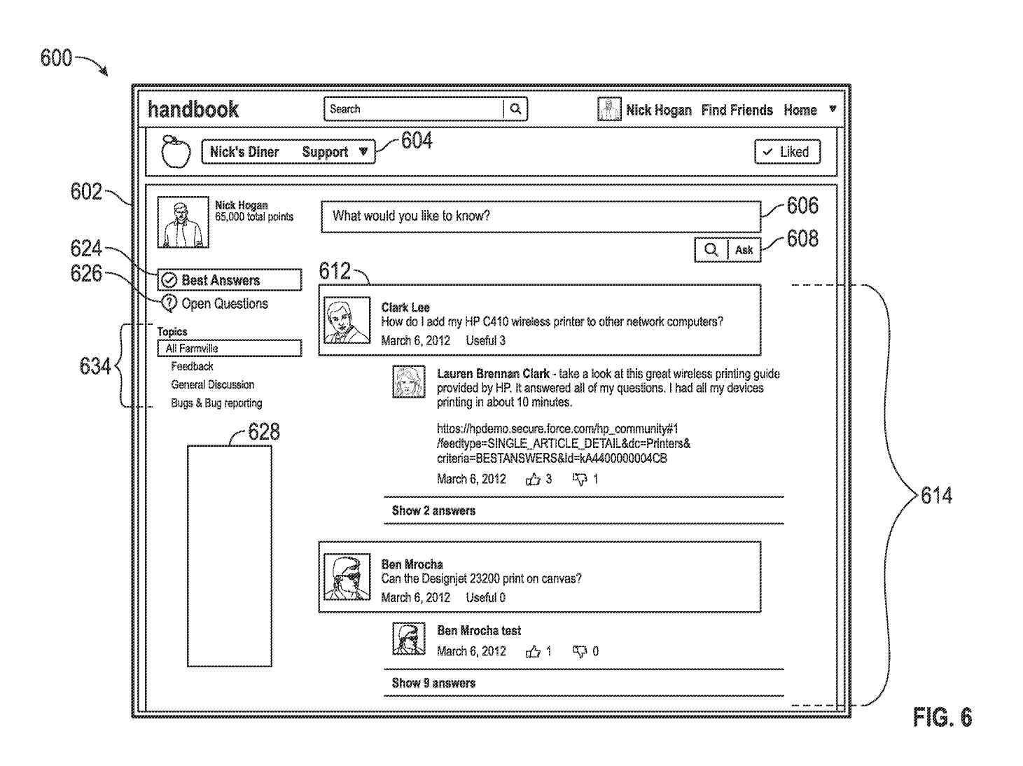

FIG. 6 is an alternate implementation of the screen layout shown in FIG. 2. More particularly, in various embodiments the Chatter Answers™ platform can provide backend company data to a front-end social networking site community (for example, using an iframe) while maintaining the branding, look and feel, and consistent user experience the user expects from his or her social networking site of choice. For example, a company may present their community/support site on Facebook. The company data presents as standard Facebook styling instead of Chatter Answers standard styling. When users click to join the Facebook based community from the company's enterprise site, a user record is automatically created for them in the company portal, and they are seamlessly logged into the Chatter Answers community as a Facebook user. In one implementation, the user's Facebook photo may be displayed instead of a Chatter photo (e.g., in order to maintain consistency of experience for Facebook users).

As users turn more and more to social networking sites for answers to questions, application 128 may include the functionality of allowing companies to provide a presence on those sites to thereby seamlessly answer questions and concerns posted by users using the social networking site, without the user having to separately log onto the company site.

By providing this functionality directly into Facebook (Facebook becomes a Chatter Answers portal), answers can be provided directly from the company's knowledgebase and articles, including video information. In addition, questions can be deflected in Facebook, showing the Best Reply, which may be chosen by a Facebook user. Further, this system allows direct, private conversation with a support agent, in a Facebook-styled feed. A user can be notified via email or Facebook Messaging when a Best Reply has been chosen, or when an Agent has responded.

Returning now to FIG. 6, an exemplary layout 600 for a customer support user interface includes a screen 602 within a browser window. The screen 602 includes branding indicia 604, a question field 606, a “Go” (or “Ask”) virtual button 608, an open questions function 626, and a best answer button 626. Search results may be displayed in a feed 612 configured to display knowledge base results, community forum results, and/or agent interaction in one or more feed fields 614. In addition, the search results may be sorted using one or more source-based filters 628 and/or one or more content filters 634, as described above in connection with FIG. 2.

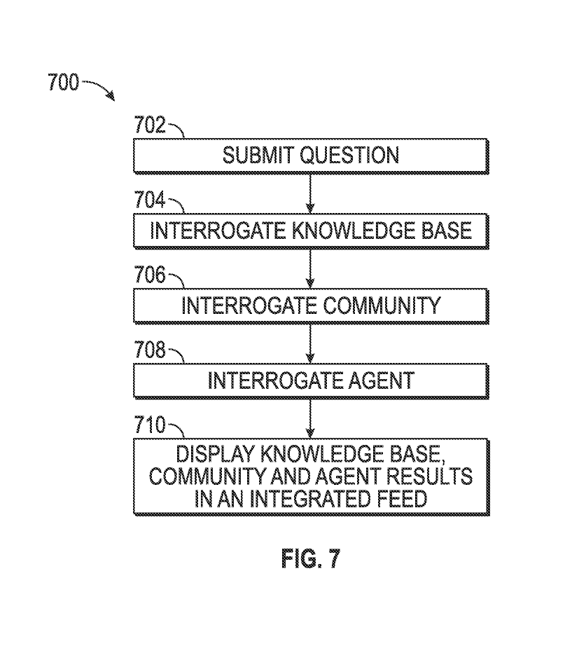

FIG. 7 is a flow diagram of an exemplary method 700 for answering a customer support question. The method 700 involves submitting a question by a user (Task 702), and thereafter interrogating a database (Task 704), interrogating at least one forum in a customer community (Task 706), and interrogating or otherwise soliciting input from a customer support agent (Task 708). The method 700 also includes displaying the knowledge base results, the community results, and the support agent results in a continuous integrated feed (Task 710).

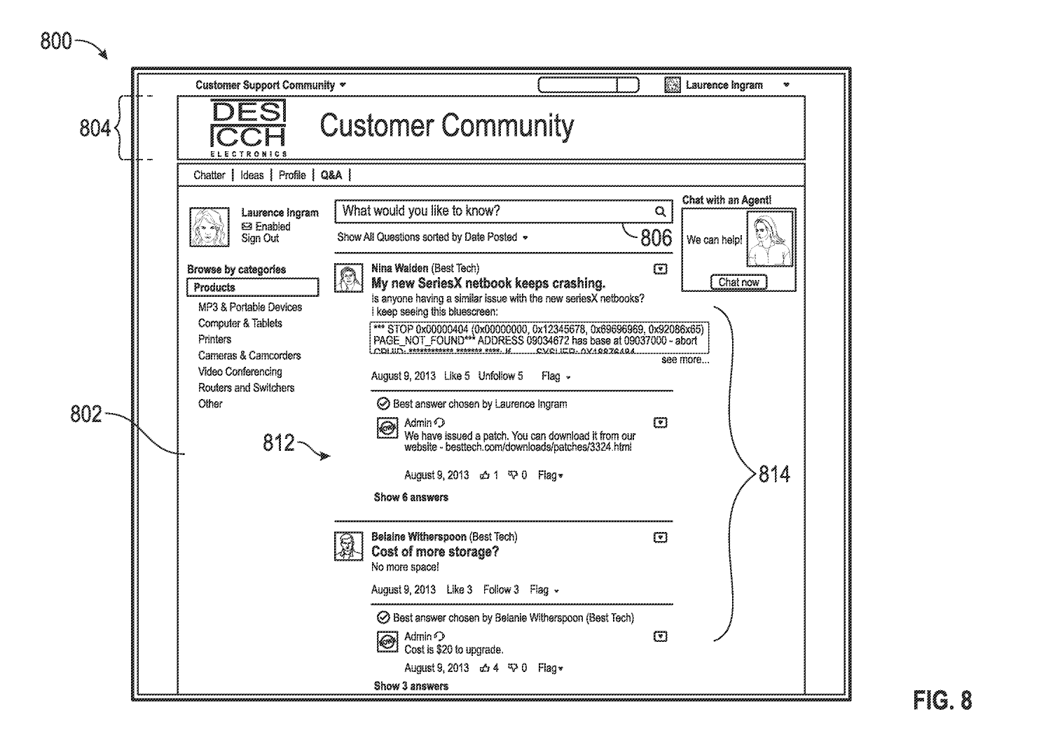

In yet a further alternative, FIG. 8 shows the product in a more traditional branded setting. More particularly, FIG. 8 depicts an exemplary layout 800 for a customer support user interface including a screen 802 within a browser window. The screen 802 includes branding indicia 804 and a question field 606. Search results may be displayed in a feed 812 configured to display knowledge base results, community forum results, and/or agent interaction in one or more feed fields 614.

A method is thus provided for providing answers in an on-line customer support site. The method may include: receiving a first question from a user; determining first results from a knowledge base; determining second results from a community; determining third results from an agent; and displaying the first results, the second results, and the third results responsive to the first question in a single, integrated feed.

In an embodiment, receiving the first question comprises: prompting the user to enter at least one search term; deflecting the at least one search term; and prompting the user to confirm the first question.

In another embodiment, deflecting comprises presenting the user with at least one candidate questions disambiguating the first question.

In another embodiment, the knowledge base comprises a first database of previously submitted questions and corresponding answers, and determining first results comprises interrogating the first database with the first question.

In a further embodiment, the community comprises at least one on-line forum, and determining second results comprises posting the first question to the at least one on-line forum. The agent comprises a human customer support agent, and determining third results comprises directing the first question to the agent and soliciting the third results from the agent.

In another embodiment, determining second results further comprises waiting a predetermined period of time after posting before directing.

A further embodiment involves opening a ticket and designating the ticket as either public or private.

In another embodiment, displaying comprises assigning respective relevance scores to the first, second, and third results, and ordering the first, second, and third results according to the respective relevance scores.

Another embodiment involves displaying at least one source filter and at least one content filter, and reordering the first, second, and third results in response to the user manipulating at least one of the at least one source filter and the at least one content filter.

In an embodiment, the method includes prompting the user to identify a best answer from among the first results, the second results, and the third results.

In a further embodiment, the method involves displaying the single, integrated feed in an iframe, and the on-line customer support site may comprise a cloud based multi-tenant computing environment.

In another embodiment, determining third results comprises presenting the first question to an agent console and feeding customer relationship management (CRM) data associated with the user to the agent on the console simultaneously with displaying the first question to the agent.

An on-line customer support user interface (UI) is also provided. The UI may include a first field configured for entering login information; a second field configured for entering a question; at least one source filter virtual button; and a single, integrated feed field configured to display search results from a knowledge database, a community forum, and agent interaction responsive to the question.

In an embodiment, the UI includes an interaction module configured to create a customer support ticket for facilitating the agent interaction.

In an embodiment, the knowledge base comprises a first database of previously submitted questions, corresponding answers, and linked articles; the community comprises at least one on-line forum; and the agent comprises a human customer support agent.

A computer application embodied in a non-transitory medium is also provided for operation by a computer processor associated with a multi-tenant server for performing the steps of: receiving a first question from a user; determining first results from a knowledge base; determining second results from a community; determining third results from an agent; and displaying the first results, the second results, and the third results responsive to the first question in a single, integrated feed.

In an embodiment, the computer application may be configured to wait for a predetermined period of time after determining the second results before determining the third results.

In another embodiment, displaying comprises presenting the first results, the second results, and the third results serially in a continuous feed which allows the user to scroll therethrough uninterrupted by conventional tabs.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to computer programming, computer networking, database querying, database statistics, query plan generation, XML and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions.

For example, an embodiment of a system or a component may employ various integrated circuit components, e.g., memory elements, digital signal processing elements, logic elements, look-up tables, or the like, which may carry out a variety of functions under the control of one or more microprocessors or other control devices. In this regard, the subject matter described herein can be implemented in the context of any computer-implemented system and/or in connection with two or more separate and distinct computer-implemented systems that cooperate and communicate with one another. That said, in exemplary embodiments, the subject matter described herein is implemented in conjunction with a virtual customer relationship management (CRM) application in a multi-tenant environment.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed:

1. A method of providing answers in an on-line customer support site, the method comprising:
receiving a first question from a user;
determining first results from a knowledge base;
determining second results from a community;
determining third results from an agent; and
displaying the first results, the second results, and the third results responsive to the first question in a single, integrated feed.

2. The method of claim 1, wherein receiving the first question comprises:
prompting the user to enter at least one search term;
deflecting the at least one search term; and
prompting the user to confirm the first question.

3. The method of claim 2, wherein deflecting comprises presenting the user with at least one candidate questions disambiguating the first question.

4. The method of claim 1, wherein the knowledge base comprises a first database of previously submitted questions, corresponding answers, and linked articles, and further wherein determining first results comprises interrogating the first database with the first question.

5. The method of claim 1, wherein the community comprises at least one on-line forum, and further wherein determining second results comprises posting the first question to the at least one on-line forum.

6. The method of claim 5, wherein the agent comprises a human customer support agent, and further wherein determining third results comprises directing the first question to the agent and soliciting the third results from the agent.

7. The method of claim 6, wherein determining second results further comprises waiting a predetermined period of time after posting before directing.

8. The method of claim 6, further comprising opening a ticket and designating the ticket as either public or private.

9. The method of claim 1, wherein displaying comprises assigning respective relevance scores to the first, second, and third results, and ordering the first, second, and third results according to the respective relevance scores.

10. The method of claim 1, further comprising displaying at least one source filter and at least one content filter, and reordering the first, second, and third results in response to the user manipulating at least one of the at least one source filter and the at least one content filter.

11. The method of claim 1, further comprising prompting the user to identify a best answer from among the first results, the second results, and the third results.

12. The method of claim 1, further comprising displaying the single, integrated feed in an iframe.

13. The method of claim 1, wherein the on-line customer support site comprises a cloud based multi-tenant computing environment.

14. The method of claim 13, wherein determining third results comprises presenting the first question to an agent console and feeding customer relationship management (CRM) data associated with the user to the agent on the console simultaneously with displaying the first question to the agent.

15. An on-line customer support user interface (UI) comprising:
a first field configured for entering login information;
a second field configured for entering a question;
at least one source filter virtual button; and
a single, integrated feed field configured to display search results from a knowledge database, a community forum, and agent interaction responsive to the question.

16. The UI of claim 15, further comprising an interaction module configured to create a customer support ticket for facilitating the agent interaction.

17. The UI of claim 15, wherein:
the knowledge base comprises a first database of previously submitted questions and corresponding answers;
the community comprises at least one on-line forum; and
the agent comprises a human customer support agent.

18. A computer application embodied in a non-transitory medium for operation by a computer processor associated with a multi-tenant server for performing the steps of:
receiving a first question from a user;
determining first results from a knowledge base;
determining second results from a community;
determining third results from an agent; and
displaying the first results, the second results, and the third results responsive to the first question in a single, integrated feed.

19. The computer application of claim 18, further configured to wait for a predetermined period of time after determining the second results before determining the third results.

20. The computer application of claim 18, wherein displaying comprises presenting the first results, the second results, and the third results serially in a continuous feed which allows the user to scroll therethrough uninterrupted by conventional tabs.
